(19) United States
(12) Patent Application Publication
(10) Pub. No.: US 2021/0097111 A1
(43) Pub. Date: Apr. 1, 2021

(54) INFORMATION PROVIDING DEVICE, INFORMATION PROVIDING METHOD AND NON-TRANSITORY STORAGE MEDIUM

(71) Applicant: JVCKENWOOD Corporation, Yokohama-shi (JP)

(72) Inventors: Shunsuke Yamamoto, Yokohama-shi (JP); Moe Fujishima, Yokohama-shi (JP); Satoru Hirose, Yokohama-shi (JP); Chieko Endo, Yokohama-shi (JP); Kakagu Komazaki, Yokohama-shi (JP); Hitomi Tadokoro, Yokohama-shi (JP)

(21) Appl. No.: 17/017,722

(22) Filed: Sep. 11, 2020

(30) Foreign Application Priority Data
Sep. 26, 2019 (JP) 2019-175821

(51) Int. Cl. G06F 16/9032; G06F 16/9035; G06F 16/9038; G06F 16/901

(52) U.S. Cl. CPC G06F 16/90332; G06F 16/9017; G06F 16/9038; G06F 16/9035

(57) ABSTRACT

An information providing device includes a search word setting unit configured to specify a keyword that is input and set the specified keyword as a search word, a feature word extractor configured to acquire information containing the search word from an external network and extract, as feature words, multiple keywords that are different from the search word from the information containing the search word, and a presentation word selector configured to select at least one presentation word to be output from among the feature words based on appearance information on the feature words.

### CROSS-REFERENCE TO RELATED APPLICATIONS

This application claims priority from Japanese Application No. 2019-175821, filed on Sep. 26, 2019, the contents of which are incorporated by reference herein in its entirety.

### FIELD

The present application relates to an information providing device, an information providing method, and a non-transitory storage medium.

### BACKGROUND

In a meeting, participating members have a discussion to thereby present new ideas or specify ideas based on remarks of the members. There is a technique to present a new keyword from a certain keyword for supporting such meetings, etc.

For example, Japanese Laid-open Patent Publication No. 2019-32741 describes a meeting system that searches information relevant to a topic of the meeting, sets at least one keyword such as a keyword that often appears in a meeting record, and searches for content that is close to the keyword from book information, SNS information, and TV program information. Japanese Laid-open Patent Publication No. 2014-85694 describes a search device that extracts a document group relevant to a keyword from multiple document groups, collects multiple document groups containing the keyword as relevant posted messages, and determines a word with a high co-occurrence frequency from the relevant posted messages as a query (a new search word).

In order to have a new idea and produce “awareness”, only presenting content and a sentence with high relevancy to the search keyword may be insufficient.

### SUMMARY

An information providing device, an information providing method, and a non-transitory storage medium are disclosed.

According to one aspect, there is provided an information providing device comprising: a search word setting unit configured to specify a keyword that is input and set the specified keyword as a search word; a feature word extractor configured to acquire information containing the search word from an external network and extract, as feature words, multiple keywords that are different from the search word from the information containing the search word; and a presentation word selector configured to select at least one presentation word to be output from among the feature words based on appearance information on the feature words.

According to one aspect, there is provided an information providing method comprising: detecting a keyword; setting the keyword for a search word; acquiring information containing the search word from an external network and extracting, as feature words, multiple keywords that are different from the search word from the information containing the search word; and selecting at least one presentation word to be output from among the feature words based on appearance information on the feature words.

According to one aspect, there is provided a non-transitory storage medium that stores a program that causes a computer to execute a process comprising: detecting a keyword; setting the keyword for a search word; acquiring information containing the search word from an external network and extracting, as feature words, multiple keywords that are different from the search word from the information containing the search word; and selecting at least one presentation word to be output from among the feature words based on appearance information on the feature words.

The above and other objects, features, advantages and technical and industrial significance of this application will be better understood by reading the following detailed description of presently preferred embodiments of the application, when considered in connection with the accompanying drawings.

### BRIEF DESCRIPTION OF THE DRAWINGS

FIG. 1 is a block diagram illustrating an example of a configuration of an information providing device according to a present embodiment.

FIG. 2 is a flowchart representing an example of processes of the information providing device according to the present embodiment.

FIG. 3 is a flowchart representing an example of processes of a search word setting unit.

FIG. 4 is a flowchart representing an example of processes of a feature word extractor.

FIG. 5 is a flowchart representing an example of processes of a presentation word selector.

FIG. 6 is a schematic view on setting a search word.

FIG. 7 is a view of an image illustrating an example of an SNS screen.

FIG. 8 is a schematic view on selecting a presentation word.

FIG. 9 is a view of an image illustrating an example of an output screen.

### DETAILED DESCRIPTION OF THE PREFERRED EMBODIMENTS

With reference to the accompanying drawings, one embodiment according to the application will be described in detail. The embodiment does not limit the application. When there are multiple embodiments, configurations obtained by combining embodiments are covered.

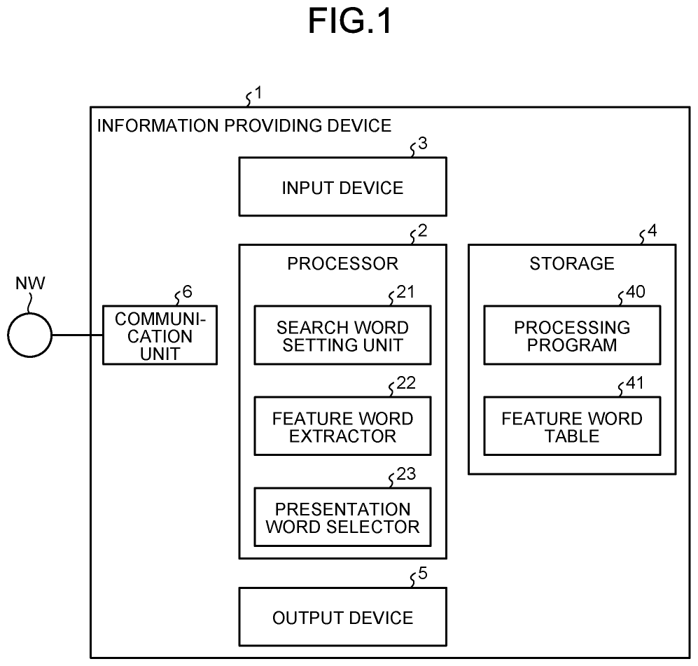

FIG. 1 is a block diagram illustrating an example of a configuration of an information providing device 1 according to the present embodiment. In the following description, the same or similar components may be denoted with the same reference numbers. In the following description, redundant description may be omitted.

As illustrated in FIG. 1, the information providing device 1 according to the embodiment is, for example, an electronic computer, such as a personal computer (PC), or an electronic device, such as a smartphone or a tablet, and includes a processor 2, an input device 3, a storage 4, an output device 5, and a communication unit 6. Each of the processor 2, the input device 3, the storage 4, the output device 5, and the communication unit 6 may be incorporated as the information providing device 1 in a single casing like a tablet, or the like, or the input device 3, the output device 5 and other devices may be independent from one another like a PC. Communication among the processor 2, the input device 3, the storage 4, the output device 5, and the communication unit 6 may be wired communication or wireless communication.

The input device 3, the output device 5, and the communication unit 6 will be described. The input device 3 is a device that detects an input that is made by a user. The input device 3 of the present embodiment is a microphone that detects words that are produced by a user. The input device 3 has only to detect words input by the user and is not limited to a microphone, and may detect inputs of characters from a keyboard, a mouse, a touch panel, or the like. The output device 5 outputs various types of information. The output device 5 is, for example, a display including a liquid crystal display or an organic EL display. The output device 5 may be a speaker that outputs sounds or a printer that outputs prints. The communication unit 6 communicates with an external network NW and transmits and receives data. The communication unit 6 acquires information of a website via the network NW. The communication unit 6 of the present embodiment acquires character information in various types of Social Networking Services (SNS). The subject from which character information is acquired is not limited to SNS.

The processor 2 executes a process of determining multiple presentation words based on an input that is made by the user and is detected by the input device 3, and outputting the determined presentation words from the output device 5. The processor 2 is, for example, a processor, such as a central processing unit (CPU), a micro controller, or an integrated circuit, such as an application specific integrated circuit (ASIC) or a field-programmable gate array (FPGA). The processor 2 processes input data from the input device 3, stores intermediate data and a process result in the storage 4, and outputs the process result to the output device 5. The processor 2 includes a search word setting unit 21, a feature word extractor 22, and a presentation word selector 23.

The search word setting unit 21 extracts words and sentences from the information that is detected by the input device 3 and sets a search word serving as a first keyword from the result of extraction. The feature word extractor 22 acquires information on the network NW based on the search word and extracts multiple feature words serving as second keywords. The presentation word selector 23 selects a presentation word serving as a third keyword from the multiple feature words and outputs the selected presentation word to the output device 5. The presentation word selector 23 also determines a method of outputting the presentation word.

The storage 4 stores various types of information. The storage 4 stores a process program 40 executed by the processor 2 and a feature word table 41 to determine a process executed by the processor 2. The storage 4 is implemented using, for example, a semiconductor memory device, such as a random access memory (RAM) or a flash memory, or a storage, such as a hard disk or an optical disk. The process program 40 is a program that causes the search word setting unit 21, the feature word extractor 22, and the presentation word selector 23 to execute various processes. The feature word table 41 is a table containing information serving as a reference of a process of extracting a feature word performed by the feature word extractor 22 and information serving as a reference of a process of selecting a presentation word performed by the presentation word selector 23. The feature word table 41 contains words, an appearing frequency of the words, and information of relevancy of the words. The feature word table 41 also contains a history of the process executed by the processor 2.

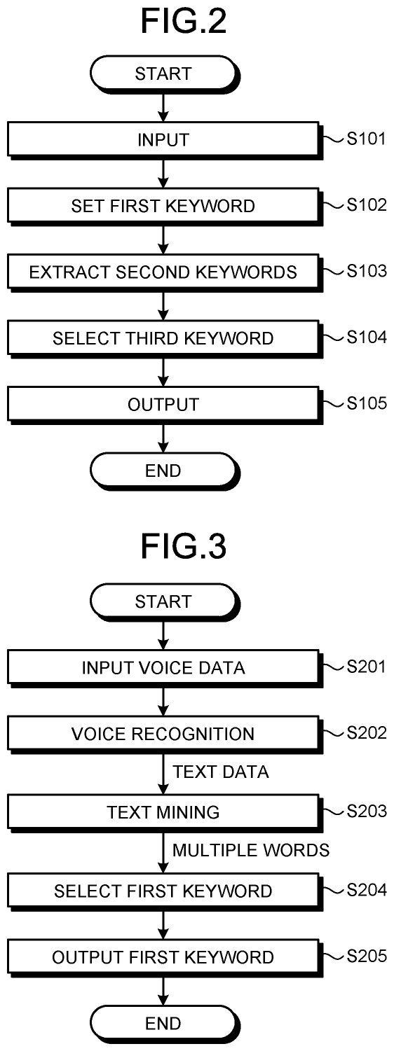

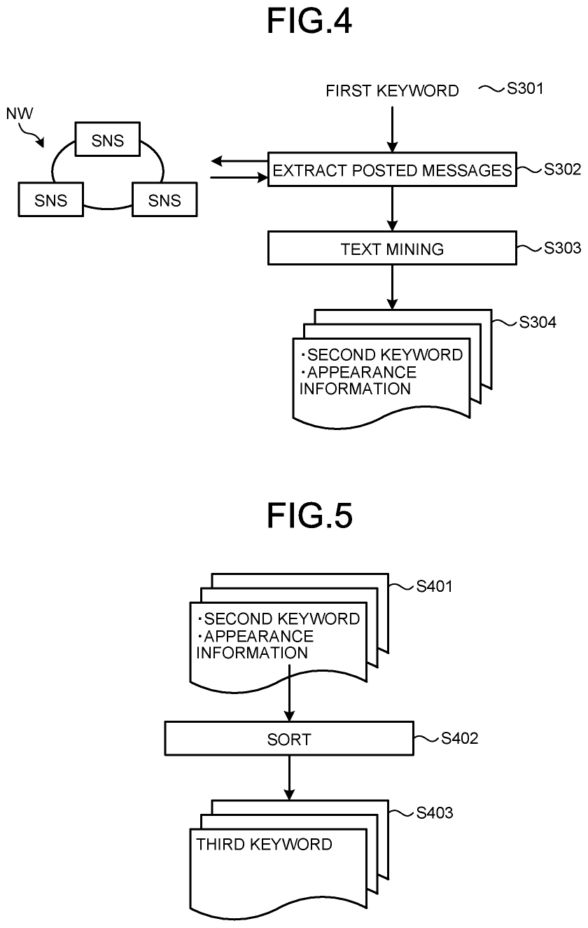

Using FIGS. 2 to 5, details of processes of the information providing device 1 according to the present embodiment will be described. FIG. 2 is a flowchart representing an example of processes of the information providing device 1 according to the present embodiment. FIG. 3 is a flowchart representing an example of processes of the search word setting unit 21. FIG. 4 is a flowchart representing an example of processes of the feature word extractor 22. FIG. 5 is a flowchart representing an example of processes of the presentation word selector 23. FIG. 2 represents the whole process performed by the information providing device 1. FIGS. 3 to 5 represent an example of the processes performed by the respective units. The present embodiment will be described as a case where information is acquired from an SNS.

Using the input device 3, the information providing device 1 acquires voice of surrounding talks, or the like, and inputs the acquired voice data to the processor 2 (step S101). The search word setting unit 21 sets a first keyword from the voice data that is input from the input device 3 to the processor 2 (step S102). The first keyword serves as a search word.

Using FIG. 3, processes of the search word setting unit 21 at step S102 will be described. The voice data is input from the input device 3 to the search word setting unit 21 (step S201) and the search word setting unit 21 executes a voice recognition process on the input voice data (step S202). The search word setting unit 21 converts the voice data into text data in the voice recognition process. The search word setting unit 21 performs text mining on the text data obtained by conversion (step S203). The method of the text mining is not particularly limited. The search word setting unit 21 acquires multiple words from the text data in text mining. The search word setting unit 21 selects a first keyword from among the words that are acquired by text mining (step S204) and outputs the selected first keyword as a search word to the feature word extractor 22 (step S205). In the present embodiment, the first keyword is selected from the multiple words that are acquired by text mining. Alternatively, all the words acquired by text mining may be used as first keywords. That is, the selecting process at step S204 need not be performed. Various processes may be employed as the process of selecting a first keyword from multiple words acquired by text mining. For example, a word with high importance and high relevancy may be a first keyword based on the importance and relevancy that is specified by text mining.

After setting the first keyword using the search word setting unit 21, the information providing device 1 extracts second keywords using the feature word extractor 22 (step S103). Specifically, the feature word extractor 22 searches information on the network NW using the first keyword as a search word and extracts multiple words different from the first keyword as second keywords. The second keywords serve as feature words.

Using FIG. 4, processes performed by the feature word extractor 22 at step S103 will be described. The feature word extractor 22 acquires the first keyword from the search word setting unit 21 (step S301). Based on the first keyword, the feature word extractor 22 searches information on the network NW using the communication unit 6 and extracts posted messages containing the first keyword in an SNS (step S302). The feature word extractor 22 performs text mining on the posted messages containing the first keyword in the SNS (step S303). Specifically, the feature word extractor 22 extracts multiple words different from the first keyword as second keywords. The feature word extractor 22 acquires appearance information on the extracted second keywords (the number of times of appearance, the frequency of appearance, or the like). The feature word extractor 22 stores the second keywords and the appearance information in association with each other in the feature word table 41 of the storage 4 (step S304).

After extracting the second keywords using the feature word extractor 22, the information providing device 1 selects a third keyword from among the second keywords using the presentation word selector 23 (step S104). The third keywords serve as a presentation word that is output to the output device 5.

Using FIG. 5, processes performed by the presentation word selector 23 at step S104 will be described. The presentation word selector 23 acquires the second keywords and the appearance information from the storage 4 (step S401). The presentation word selector 23 may acquire the second keywords and the appearance information from the feature word extractor 22. The presentation word selector 23 then sorts the second keywords based on the appearance information (step S402). In other words, the presentation word selector 23 ranks the second keywords based on parameters that are contained in the appearance information. The presentation word selector 23 selects the third keyword from among the sorted second keywords (step S403). For example, the presentation word selector 23 selects the second keyword that is ranked high in number of times of appearance (in the top five, or the like) as the third keyword. The sorting may be in any one of an ascending order and a descending order.

The information providing device 1 outputs the third keyword that is selected using the presentation word selector 23 as a presentation word from the output device 5 (step S105).

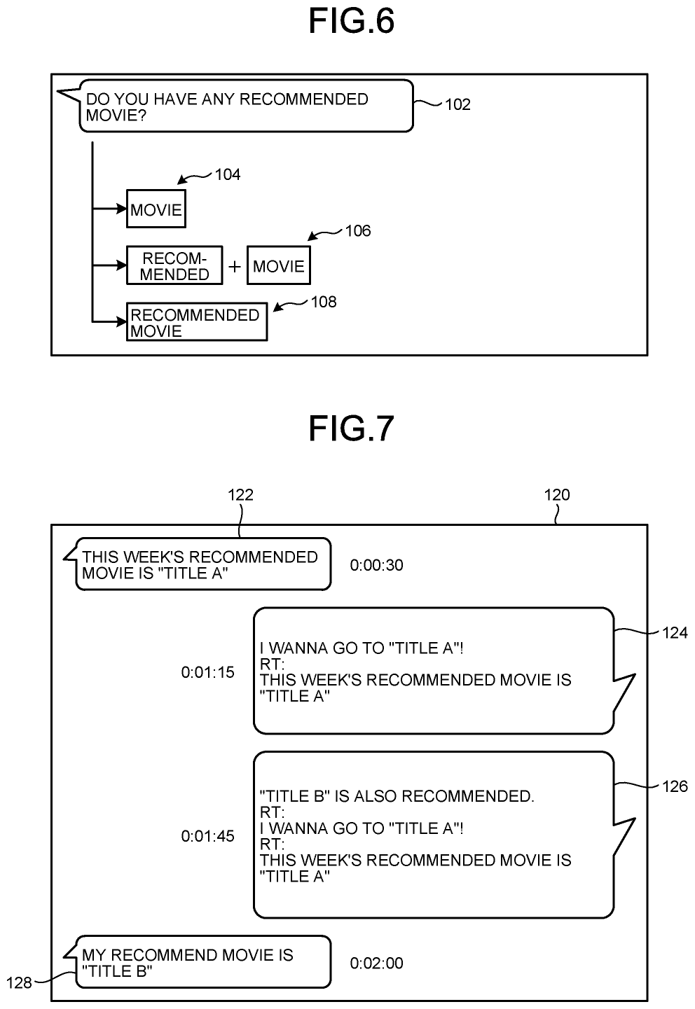

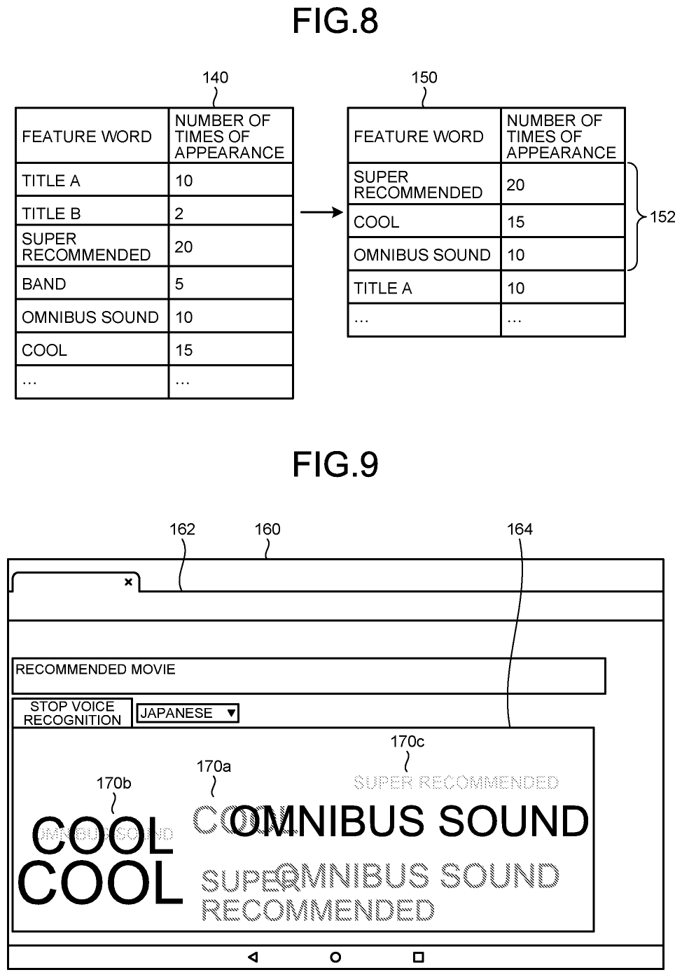

Using FIGS. 6 to 9, an example of the processes of the respective units of the processor 2 will be described. FIG. 6 is a schematic diagram on setting a search word. FIG. 7 is an image view illustrating an example of an SNS screen. FIG. 8 is a schematic diagram on selecting a presentation word. FIG. 9 is an image view illustrating an example of an output screen.

When the input device 3 detects a voice of “Do you have any recommended movie?”, the search word setting unit 21 detects a text 102 of “Do you have any recommended movie?” by the voice recognition process. By performing the text mining, the search word setting unit 21 extracts a word 104, words 106, words 108, etc. The word 104 is of the case where a single word of “movie” is extracted from the text 102. The words 106 are of the case where multiple words of “recommended” and “movie” are extracted from the text 102. The words 108 are of the case where a single set of words of “recommended movie” is extracted from the text 102. The search word setting unit 21 of the present embodiment extracts the single set of words of “recommended movie” as a first keyword.

The feature word extractor 22 extracts feature words based on the first keyword. Using “recommended movie” as a search word, the feature word extractor 22 searches the SNS and extracts posted messages illustrated in FIG. 7. The SNS screen 120 contains posted messages 122, 124, 126 and 128 containing the first keyword of “recommended movie”. The SNS screen 120 may contain posted messages not containing the first keyword. As described below, when the SNS screen 120 containing the first keyword includes successive posted messages, the feature word extractor 22 extracts the posted messages that meet a predetermined condition. The feature word extractor 22 performs text mining on the texts of the posted messages 122, 124, 126 and 128 that are contained in the extracted SNS screen 120 and extracts words other than the first keyword as second keywords. The feature word extractor 22 extracts multiple posted messages from a subject to be searched and extracts words other than the first keyword from the extracted texts. The feature word extractor 22 extracts the extracted second keywords and the numbers of times of appearance and stores the second keywords and the numbers of times of appearance in the feature word table 41. Accordingly, the feature word extractor 22 is able to store data 140 illustrated in FIG. 8 in the feature word table 41. The data 140 illustrated in FIG. 8 is a result of the extraction obtained by searching, in addition to the SNS screen 120 in FIG. 7, at least another SNS screen (containing keywords “super recommended”, “band”, “omnibus sound”, “cool”, etc.,). In the present embodiment, as for the data 140, title A, title B, super recommended, band, omnibus sound, cool, etc., are extracted as feature words, and the feature words are associated with the numbers of times of appearance, respectively.

The presentation word selector 23 selects a third keyword from the second keywords. In the example illustrated in FIG. 8, the presentation word selector 23 performs sorting process based on the numbers of times of appearance on the data 140 and creates data 150. The data 150 is data obtained by extracting the feature words whose corresponding numbers of times of appearance are equal to or larger than a predetermined number from among the data 140. When the numbers of times of appearance are equal to each other, for example, the feature words are arranged in alphabetical order. The presentation word selector 23 selects, for example, the top three feature words 152 from among the data 150 as presentation words. In the present embodiment, the top three feature words 152 are “super recommended”, “cool” and “omnibus sound”, and thus are selected as the presentation words. The numbers of times of appearance of both the “omnibus sound” and “title A” are 10 and “omnibus sound” comes first in alphabetical order, and thus “omnibus sound” is selected. Needless to say, when the numbers of times of appearance are equal to each other, all the feature words may be selected as the presentation words. However, there is a possibility that there are a large number of feature words whose numbers of times of appearance are equal to one another and thus not feature words “in the top three” but only “the top three” feature words are selected.

In the present embodiment, the numbers of times of appearance are used as the appearance information, but the appearance information is not limited thereto. The appearance information is preferably information that can be associated with a word in information that is acquired by the feature word extractor 22 via the network and, for example, frequency of appearance (the number of times of appearance within a predetermined time), the number of times of citation (the number of accesses and the number of responses), or the like, can be used. The appearance information on the second keyword may be used as a parameter representing relevancy with the first keyword. The feature word extractor 22 may set relevancy of the extracted second keyword with the first keyword by relatively comparing the second keyword with the second keywords that has been stored in the feature word table 41 of the storage 4 or existing dictionary data (determining synonyms, similar words, or the like).

The presentation word selector 23 is able to select a presentation word according to various standards. For example, the presentation word selector 23 may have a standard in which a keyword with high relevancy or a keyword with high frequency of appearance is selected as a presentation word or may have a standard in which a keyword with low relevancy or a keyword with low frequency of appearance is selected as a presentation word. Adjusting the standard makes it possible to select a presentation word along input information, or to select a presentation word that is erratic to input information. This enables each information providing device 1 to be given with a different various feature (individuality). The features are, for example, “features of information provision (device)”, “types of information provision”, or the like. The presentation word selector 23 may select antonym or opposite words as the keywords or may select the keywords that are selected based on times associated with a feature word (for example, integration time of posting).

After selecting the presentation word serving as a third keyword, the information providing device 1 outputs the presentation word by the output device 5. As illustrated in FIG. 9, the information providing device 1 displays presentation words 170a, 170b and 170c on a display section 164 on a window 162 of a screen 160. In the present embodiment, the presentation words 170a, 170b and 170c are “super recommended”, “cool” and “omnibus sound” that are selected as the presentation words. By shifting the positions of display of the presentation words 170a, 170b and 170c and varying the densities of the characters, the output device 5 makes a display such that each of the presentation words gradually disappears after being displayed. The display method that is employed by the output device 5 is not limited to the screen 160, and a display may be made using a system of word cloud, mind map, mandala chart, or the like. The information providing device 1 may display a sentence obtained by connecting the multiple third keywords on the output device 5. The information providing device 1 preferably change the display method (display mode) that is employed by the output device 5 according to the feature of the third keyword. The feature of the third keywords includes, for example, a feature with a large number of times of appearance, a feature with a large number of times of citation, or a feature of unique, etc. As the change of the display method, for example, a change in the color of characters, size, time of display, mode of balloon, or the like, can be adapted.

The information providing device 1 may make voice output of the third keyword using the output device 5. In this case, the processor 2 controls timing when voice is produced from the output device 5. For example, the processor 2 accumulates the third keywords while the surrounding members are talking and the voice input continues, and the output device 5 makes voice output of the third keywords at a timing when the surrounding members turn to be quiet and the voice input stops.

As described above, the information providing device 1 uses a word that is extracted from voice input as a search word (first keyword). The information providing device 1 uses, as feature words (second keywords), multiple words different from the first keyword that are extracted from the posted messages containing the first keyword in an SNS. The information providing device 1 uses words that are selected from the second keywords as the presentation words (third keywords). The information providing device 1 extracts the second keywords by performing searching based on the first keyword and further selects the third keywords based on the appearance information on the second keywords, thereby being capable of presenting new keywords that can trigger an idea. That is, by selecting the extracted keywords based on various standards without simply extracting keywords relevant to the search word, it is possible to present new keywords that can trigger an idea along the purpose.

The information providing device 1 is usable also as application software to enjoy conversations. For example, the user makes a voice input of a first keyword to the information providing device 1 in a form of conversation with the information providing device 1. The information providing device 1 searches for second keywords for a first keyword of which the voice input is made by a user, and makes a voice output of third keywords. The user makes further voice input of a new first keyword to the information providing device 1 in a form of a response to the third keyword of which the voice output is made by the information providing device 1. Repeating this causes appearance of new keywords one after another from both the user and the information providing device 1. The information providing device 1 selects third keywords based on the appearance information, and accordingly keywords with low relevancy may be selected as a presentation word. This causes a change in the topic and thus enables conversations that does not make the user bored.

In the information providing device 1, when searching information on the network NW based on a first keyword, the feature word extractor 22 preferably searches posted messages in an SNS within a predetermined time before and after the input of the first keyword. Alternatively, a period of posted messages to be searched is set (for example, 10 years ago) and search is made. When the number of second keywords that are extracted from the result of the search for the predetermined time is under a predetermined number, the time of the search may be increased. When the number of second keywords that are extracted from the result of the search for the predetermined time is under the predetermined number, another first keyword may be added or the first keyword may be replaced. This makes it possible to narrow the subject to be searched and to extract words to be extracted that fits the purpose more.

More specifically, the feature word extractor 22 extracts second keywords from posted messages in the SNS that appeared between a time t−Δt1 and a time t+Δt1′, where t is a time at which a first keyword is input thereto from the search word setting unit 21 and Δt1 and Δt1′ are predetermined times. Δt1 and Δt1′ may be different from each other or may be equal to each other. Any one of or both Δt1 and Δt1′ may be 0. By setting values larger than 0 for Δt1 and Δt1′, the feature word extractor 22 is able to increase the number of posted messages to be searched. When Δt1 and Δt1′ are 0, the feature word extractor 22 is able to perform extraction based on a point of time at which extraction is performed again and thus acquire different results of the extraction. When the number of extracted keywords is under the predetermined number (for example, five words), the feature word extractor 22 increases the period of the extraction from the period between Δt1 and Δt1′ to a period between a time t−Δt1−Δt2 and a time t+Δt1′+Δt2′, where Δt2 and Δt2′ are additional times, and then extracts second keywords from posted messages in the SNS appearing during the increased period of the extraction. Δt2 and Δt2′ may be times different from each other or may be times that are equal to each other. Any one of or both the Δt2 and Δt2′ may be 0. This makes it possible to narrow the subject to be searched and to extract words that fit the purpose more. Setting values larger than 0 for Δt2 and Δt2′ makes it possible to increase the number of posted messages to be searched. When Δt2 and Δt2′ are 0, the feature word extractor 22 is able to perform the extraction based on a point of time at which the extraction is performed again and thus acquire different results of the extraction.

The information providing device 1 may use, as the appearance information on the second keywords that are selected by the presentation word selector 23, for example, scores each of which is calculated by multiple parameters, such as the number of times of appearance, the number of times of citation, etc. For example, a score may be calculated by multiplying the number of times of appearance by the number of times of citation.

On searching posted messages in an SNS using the feature word extractor 22, the information providing device 1 may judge a positive/negative feeling or mood of a SNS contributor on posting from emotional icons and pictorial symbols contained in message sentences, etc., and add a result of the judgement to the extracted information. This enables the information obtained from the emotional icons and the pictorial symbols to be included in the appearance information of the feature words.

The information providing device 1 performs the text mining as the process performed by the search word setting unit 21 and the feature word extractor 22, and machine learning such as deep learning may be combined with the text mining. This enables the search word setting unit 21 and the feature word extractor 22 to predict a single word from a fragmental keyword, extract keywords and multiple relevant words therewith, and extract one phrase based on the keywords. Furthermore, the feature word extractor 22 may, based on the first keyword, incorporate a predicted word, a relevant word therewith, and a phrase into the second keywords.

The feature word extractor 22 may perform, instead of the text mining, web mining on webpages based on the first keyword and thus acquire multiple second keywords that are different from the first keyword and the appearance information on the second keywords.

The feature word extractor 22 may search posted messages in the SNS again using the second keyword or the third keyword as a new first keyword. For example, the feature word extractor 22 may repeatedly execute an process of searching posted messages in the SNS using the second keyword or the third keyword as a new first keyword for a predetermined number of times (for example, five times). The third keywords that are acquired during the process may be displayed on the output device 5 sequentially. Accordingly, the initial first keyword as well as new keywords that derive from the second keywords and the third keywords are obtained and it is thus possible to broaden a range of the keywords that trigger an idea.

The information providing device 1 may previously register/store attribute information on users who make voice inputs, such as participants of a meeting, and, when searching second keywords, search posted messages in SNS with an attribute different from that of the participants of the meeting based on the attribute information on the user. For example, when males or young individuals are main members of the meeting, second keywords can be extracted from posted messages by females or elderly individuals inversely. Accordingly, it is possible to present new keywords that are obtained from a point of view different from that of the participants in the meeting.

The output device 5 is also able to display a history of results by a replay function. At that time, the presentation word selector 23 selects third keywords from multiple second keywords that are saved in the feature word table 41 of the storage 4 and outputs the third keywords to the output device 5. The output device 5 may have a button switch for executing the replay function. Alternatively, when the output device 5 is a touch-panel display, a button for executing the replay function may be displayed on a screen thereof. This makes it possible to display the third keywords again on the output device 5 when the third keywords that are displayed on the output device 5 is missed, or when the user wants to see the third keywords again.

In the information providing device 1 according to the present application, the input device 3 and the output device 5 are not essential components. For example, when the information providing device 1 is a server, the information providing device 1 may be configured such that the communication unit 6 receives information containing a first keyword as an input from at least one external terminal device via the network NW and sends third keywords as an output to the external device.

According to the application, it is possible to efficiently present new keywords that possibly trigger an idea.

Although the application has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information providing device comprising:
a search word setting unit configured to specify a keyword that is input and set the specified keyword as a search word;
a feature word extractor configured to acquire information containing the search word from an external network and extract, as feature words, multiple keywords that are different from the search word from the information containing the search word; and
a presentation word selector configured to select at least one presentation word to be output from among the feature words based on appearance information on the feature words.

2. The information providing device according to claim 1, wherein the feature word extractor is further configured to extract the feature words from information that appears on the external network between a time t−Δt1 and a time t+Δt1′, where t is a time at which the search word is input thereto from the search word setting unit 21 and Δt1 and Δt1′ are predetermined times.

3. The information providing device according to claim 2, wherein the feature word extractor is further configured to, when the number of the extracted feature words is under a predetermined number, increase a period of the extraction from a period between Δt1 and Δt1′ to a period between a time t−Δt1−Δt2 and a time t+Δt1′+Δt2′, where Δt2 and Δt2′ are additional times, and extract the feature words from the information appearing on the network within the increased period of the extraction.

4. The information providing device according to claim 1, further comprising:
an input device configured to input the keyword to the search word setting unit; and
an output device configured to output the at least one presentation word selected by the presentation word selector.

5. The information providing device according to claim 4, wherein the appearance information contains numbers of times of appearance of the feature words, and
the presentation word selector is further configured to select the at least one presentation word from among the feature words based on the numbers of times of appearance and to change a method of outputting the at least one presentation word by the output device.

6. The information providing device according to claim 4, wherein the presentation word selector is further configured to calculate a score based on the appearance information on each of the feature words, regard the feature word whose score is within a predetermined ranks as the at least one presentation word, and change the method of outputting the at least one presentation word by the output device according to the score.

7. The information providing device according to claim 4, further comprising a storage configured to store the feature words that are extracted by the feature word extractor in a feature word table,
wherein the presentation word selector is further configured to select the at least one presentation word from among the feature words that are stored in the feature word table and output a history of the selected at least one presentation word from the output device.

8. The information providing device according to claim 4, wherein the input device is further configured to detect a voice; and
the search word setting unit is further configured to specify the keyword from the voice.

9. An information providing method comprising:
detecting a keyword;
setting the keyword for a search word;
acquiring information containing the search word from an external network and extracting, as feature words, multiple keywords that are different from the search word from the information containing the search word; and
selecting at least one presentation word to be output from among the feature words based on appearance information on the feature words.

10. A non-transitory storage medium that stores a program that causes a computer to execute a process comprising:
detecting a keyword;
setting the keyword for a search word;
acquiring information containing the search word from an external network and extracting, as feature words, multiple keywords that are different from the search word from the information containing the search word; and
selecting at least one presentation word to be output from among the feature words based on appearance information on the feature words.
